(19) United States
(12) Patent Application Publication
(10) Pub. No.: US 2018/0160648 A1
(43) Pub. Date: Jun. 14, 2018

(54) REMOTE CONTROLLED MOVABLE PET FEEDER DEVICE

(71) Applicant: Johnson Goh, Singapore (SG)

(72) Inventor: Johnson Goh, Singapore (SG)

(21) Appl. No.: 15/836,284

(22) Filed: Dec. 8, 2017

Related U.S. Application Data
(60) Provisional application No. 62/432,099, filed on Dec. 9, 2016.

(51) Int. Cl. A01K 5/01; A01K 15/02; A01K 5/02

(52) U.S. Cl. CPC A01K 5/0114; A01K 15/025; G05B 19/04; A01K 5/0291; A01K 5/0275

(57) ABSTRACT

A pet feeder device whose movements and dispensing/feeding times can be controlled remotely by a software application on a computing device, comprising: a wireless transceiver configured to send and receive data packets over a wireless network; at least one food storage compartment; a food dispensing port configured to provide access to the at least one food storage compartment; a locomotive device; and a control system configured to: communicate with the wireless transceiver; control operation of the locomotive device in order to cause movement of the pet feeder device; and control access to the food storage compartment.

### INCORPORATION BY REFERENCE TO ANY PRIORITY APPLICATIONS

Any and all applications for which a foreign or domestic priority claim is identified in the Application Data Sheet as filed with the present application are incorporated by reference under 37 CFR 1.57 and made a part of this specification.

### BACKGROUND

### Field

The present disclosure pertains generally to a toy for pets, like dogs, with a food and/or treats dispenser. More particularly, the present disclosure relates to a ball-shaped pet feeder device whose movements and dispensing or feeding times can be controlled remotely by a software application on a computing device, such as a smart phone.

### Description of the Related Art

Dogs are thinking creatures with natural instincts such as digging, chasing, and socializing. Dogs left alone without stimulation in yards or a home environment can grow bored, leading to a condition commonly known as the “bored-dog problem.” “Bored-dog problem” is a condition that occurs when dogs experience acute boredom at home or another environment due to long periods of neglect and a lack of stimulation. In many cases, this brings about destruction and mayhem in a household, where furniture gets chewed up and things get toppled to the ground. Common symptoms shown by dogs with this condition include aggressive behavior, incessant barking, and whining.

### SUMMARY

In accordance with certain features, aspects and advantages of at least one of the embodiments disclosed herein, a pet feeder device can include a wireless transceiver configured to send and receive data packets over a wireless network, at least one food storage compartment, a food dispensing port configured to provide access to the at least one food storage compartment, a locomotive device, and a controller. The controller can be configured to communicate with the wireless transceiver, control operation of the locomotive device in order to cause movement of the pet feeder device, and control access to the food storage compartment.

The pet feeder device can include a food dispensing port door, wherein the controller is further configured to control access to the food storage compartment by opening the food dispensing port door. The locomotive device of the pet feeder device can include a trackball, a trackball holder configured accommodate the trackball and allow rotational movement of the trackball and prevent translational movement, and a gear box configured to communicate with the controller and rotate the trackball and thereby cause movement of the pet feeder device. The pet feeder device can include a speaker configured to project recordings and live audio, wherein the controller can be further configured to turn the speaker on and off. The pet feeder device can also include at least one light configured to illuminate on sides of the device, wherein the controller can be further configured to turn the light on and off.

The pet feeder device can also include a microphone, wherein the controller is further configured to transmit sound captured by the microphone to the wireless transceiver. The pet feeder device can include a weight sensor configured to detect the weight of the at least one food storage compartment. The controller of the pet feeder device can be configured to receive the detected weight of the at least one food storage compartment from the weight sensor and communicate such detected weight to the wireless transceiver, wherein the wireless transceiver configured to send a notification over the wireless network if the detected weight falls below a threshold value. Additionally, the controller of the pet feeder device can be configured to rotate the pet feeder device according to a random or pseudo-random pattern. The pet feeder device can further include a lid, a top cover portion comprising an opening that aligns with the food dispensing port, and a bottom cover portion, wherein the lid can be configured to secure to the top cover portion and the top cover portion is configured to secure to the bottom cover portion. The lid, a top cover portion, and a bottom cover portion can be substantially waterproof and/or substantially shockproof. The pet feeder device can alternatively include a rotation motor configured to rotate the at least one food storage compartment, wherein the controller of the pet feeder device is further configured to control access to the food storage compartment by rotating the at least one food storage compartment to align with the food dispensing port.

The pet feeder device can include a camera, wherein the controller can be further configured to turn the camera on and off and transmit data captured by the camera to the wireless transceiver. The pet feeder device can include a gyroscope configured to detect when the pet feeder device rotates past a threshold balancing point and communicate the detected rotation data to the controller, wherein the controller can be configured to receive the rotation data from the gyroscope and communicate with the locomotive device to alter the movement of the pet feeder device in order to keep the camera substantially level. The pet feeder device can include an accelerometer configured to detect when the pet feeder device rotates past a threshold balancing point. The accelerometer can be configured to communicate the detected rotations of the pet feeder device past the threshold point to the controller, and the controller can be configured to communicate the detected rotations to the wireless transceiver. The pet feeder device can also include an RFID sensor configured to detect the presence of an RFID tag, wherein the controller can be configured to communicate with the RFID sensor, and, in response to the RFID sensor detecting the presence of the RFID tag, control operation of the locomotive device in order to cause movement of the pet feeder device in a direction towards the RFID tag. The controller of the pet feeder device can be configured to control access to the food storage compartment by rotating, with the rotation motor, the at least one food storage compartment to align with the food dispensing port automatically at a pre-set feeding time.

One example of a method of operating a pet feeder device can include: receiving, by a wireless transceiver of the pet feeder device, data packets over a wireless data network, the data packets comprising at least one movement instruction; controlling, by a controller of the pet feeder device, operation of a locomotive device in order to cause movement of the pet feeder device based at least in part on the at least one movement instruction; receiving, by the wireless transceiver, data packets comprising at least one feeding instruction; and controlling, by the controller, access to a food storage compartment based at least in part on the at least one feeding instruction.

The term ‘comprising’ as used in this specification means ‘consisting at least in part of’. When interpreting each statement in this specification that includes the term ‘comprising’, features other than that or those prefaced by the term may also be present. Related terms such as ‘comprise’ and ‘comprises’ are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

It should be understood that alternative embodiments or configurations may comprise any or all combinations of two or more of the parts, elements or features illustrated, described or referred to in this specification.

This invention may also be said broadly to consist in the parts, elements and features referred to or indicated in the specification of the application, individually or collectively, and any or all combinations of any two or more said parts, elements or features.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting. Where specific integers are mentioned herein which have known equivalents in the art to which this invention relates, such known equivalents are deemed to be incorporated herein as if individually set forth.

### BRIEF DESCRIPTION OF THE DRAWINGS

FIG. 1 illustrates a top view of an embodiment of a pet feeder device.

FIG. 2 illustrates a perspective view of the pet feeder device of FIG. 1.

FIG. 3 illustrates a side view of the pet feeder device of FIG. 1.

FIG. 4 illustrates a front view of the pet feeder device of FIG. 1.

FIG. 5 illustrates another side view of the pet feeder device of FIG. 1.

FIG. 6 illustrates a back view of the pet feeder device of FIG. 1.

FIG. 7 illustrates an exploded view of the pet feeder device of FIG. 1.

### DETAILED DESCRIPTION OF SOME EMBODIMENTS

It can be important to keep pets occupied with a toy. But some pets, like dogs, are quick learners, and toys that do not stimulate a pet's natural instincts can lose their appeal very quickly. Pet toys that are coupled with a food rewarding and dispensing system can help keep a dog or other pet entertained and provide sufficient stimulation to the pet's senses.

To maintain a healthy lifestyle, pets require a healthy diet and feeding regimen. One key to maintaining such a lifestyle is consistent application of feeding regimen. Instead of one large meal a day, it can be better to apportion food throughout the day with three or four feedings. Spacing out feeding times can help prevent common digestive problems in pets resulting from consuming food so quickly that they do not even bother to chew.

Many people fail to keep their pets happy and healthy because of busy time schedules. Busy time schedules can prevent pet owners or caretakers from being able to consistently provide meals three to four times a day and from keeping their pets entertained. Some pets suffer from obesity because they maintain an unhealthy eating and sleeping regimen and fail to obtain an appropriate amount of exercise. One way to solve these problems is to have a toy that can make the pet work for its food, which stimulates its foraging instincts, and also to space out feeding times.

The following summary provides a description of some embodiments of the present disclosure. This summary is not an extensive overview, and it is not intended to identify all elements or to delineate the scope thereof.

The present disclosure provides a ball-shaped pet feeder device that can dispense food, such as dry food. The movements of the device can be remotely controlled through a software application on a computing device over a Wireless network (e.g., Wi-Fi). In some embodiments, the pet feeder device can include a rotatable dry food storage component with at least one or more compartments, a motor component, an outer shell component with a treat opening, an accelerometer, a Radio Frequency Identification (RFID) sensor, a weight sensor, a double-locked cover component, a trackball, a multipoint control unit (MCU), and a speaker component. The accelerometer can sense when the ball rolls. When the ball rolls and tips the balance beyond a certain threshold point, the MCU is activated to transmit a signal to send a wireless electronic communication to the application, which will register the rotation as “one roll.”

The dry food storage component can include one or more food compartments, such as one, two, three, or more compartments. The food storage component can be aligned with a treat opening on the outer shell component in order to dispense food from the ball. During a feeding time, the MCU can cause the motor component to turn and rotate the food storage component so that a food compartment will become aligned with the treat opening for food dispensing.

In some embodiments, the pet feeder can include a camera component, a speaker component, and/or a microphone component. The camera component can provide a live stream of the camera's view to a user. The speaker component can broadcast voice recordings or the user's live voice through the application to the receiver on the pet feeder. The microphone component can transmit sound back to the user or activate a notification through the software application in the device.

In some embodiments, the pet feeder device can be set to move automatically in random, pseudo-random, or defined patterns using the application. This can help stimulate the pet even when the owner is busy at home or away from the pet's presence.

In some embodiments, the pet feeder device can sense different pets via a RFID sensor that can sense RFID pet tags. The RFID sensor can be used to differentiate between different pets. The pet feeder device can sense proximity of the RFID pet tags and interact with the pet. The feeder can follow the pet and move away or towards it when it comes close, which can help keep it entertained. The RFID tags can also transmit information, such as estimated daily burnt calories to the feeder ball. The pet feeder can determine if the pet has exercised enough, based on daily exercise goals, and increase or decrease the speed and movement patterns. In some embodiments, the feeder can detect the location of the RFID tags and move towards them, such as when the pet has not reached its daily exercise goals.

The pet feeder device can communicate with the user through a designated software application. The application can receive wireless information from the MCU via a cloud server. The application can display food storage levels in the food storage component calculated based on data received from the weight sensor component. When food storage level is low or falls below a threshold value (which could be set by a user), the MCU can send one or more notifications to the user through the application. The application can be configured for the user to remotely turn the power on and off by transmitting a wireless signal to the MCU in the pet feeder device. In some embodiments, the application can remotely stream a live view of the camera component on the pet feeder device.

The application can be configured to set specific feeding times. At each feeding time, the opening of the dry food storage compartment can be positioned to align with the treat opening. This can be used to schedule feeding times and space out the feeding for the pet. In some embodiments, the treat opening can be an orifice that is always open and provides access to the food when properly aligned with the food storage compartment. In some embodiments, the treat opening has a door that is automatically opened during feeding time and provides access to the food storage compartment. In other embodiments, the treat opening door is configured to open when the pet feeder device is tapped one or more times. For example, the treat opening door can be configured to open when the pet feeder is tapped one, two, three, four, five, or more times.

The application can be configured to remotely control movement of the feeder device. The feeder device can be moved using the trackball. Movement of the feeder device can be sped up, slowed down, and/or stopped suddenly by controlling operation of the trackball.

The application can be configured to provide a history of the number of rolls detected by the accelerometer in a graph or other display over a defined time period (e.g., minutes, hours, days, weeks, and the like). The user can set a goal for the number of rolls. If the number of rolls is not achieved, the MCU can be configured to send a notification to the application and prompt the user to send the feeder device to look for, and interact with, the pet. The application can be configured to initiate games and/or challenges for the pet alone, or for both the pet and owner. Points can be earned when a game is completed, and these points can be accumulated over time and displayed in the application.

The application can be configured to allow users to record their voices in the application, which can be assigned to different feeding time alarms. The user can also speak live to their pet through the application, which is output by the speaker component on the feeder device. Each account in the application can be configured to pair with any number of RFID pet tags.

Although certain embodiments and examples are disclosed herein, inventive subject matter extends beyond the examples in the specifically disclosed embodiments to other alternative embodiments and/or uses, and to modifications and equivalents thereof.

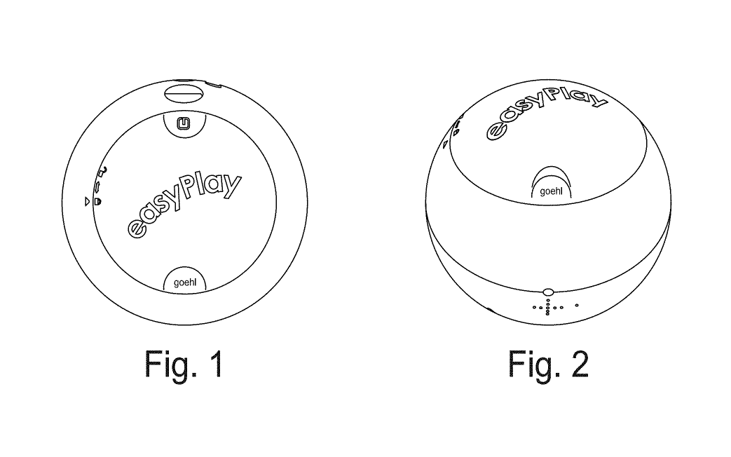

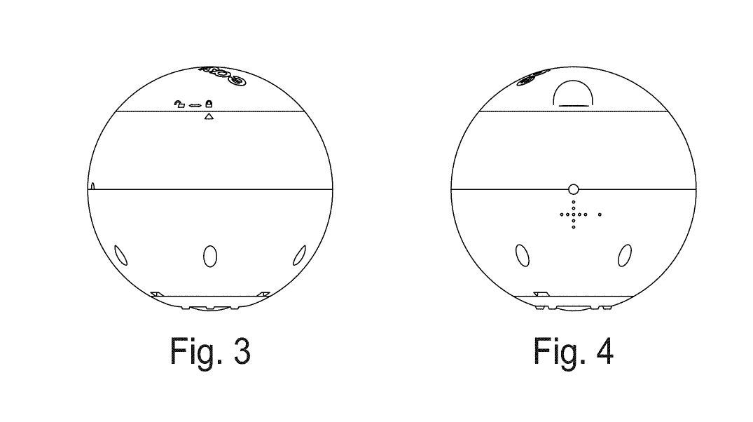

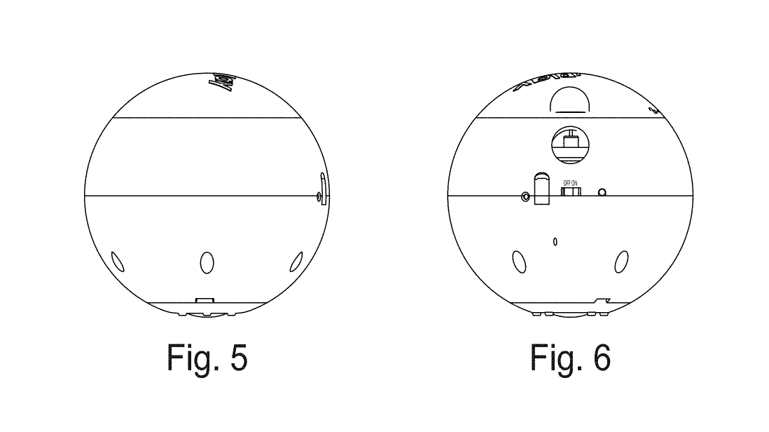

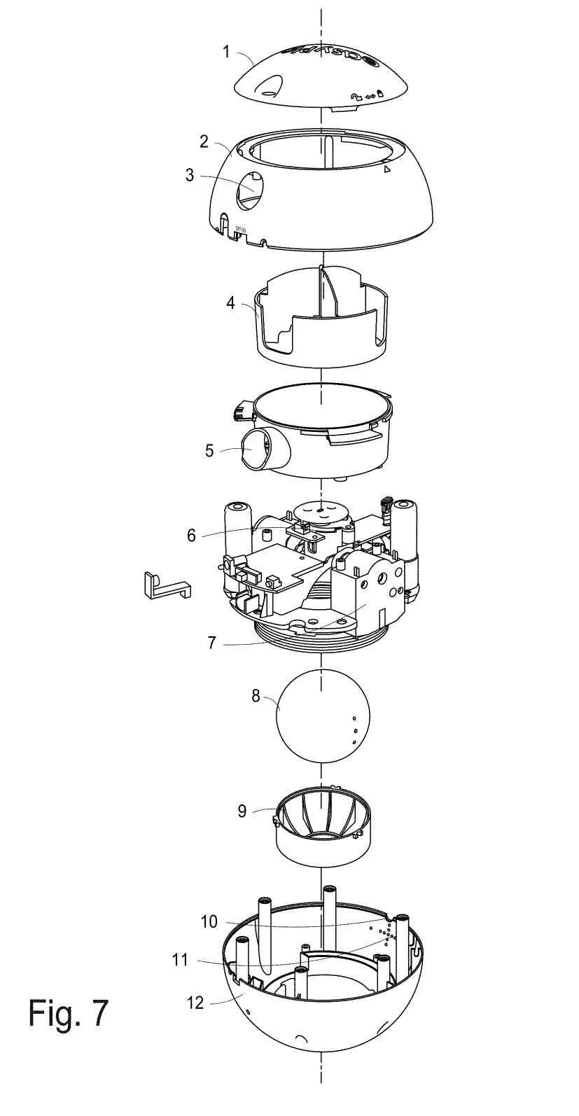

FIG. 1 through FIG. 6 illustrate a pet feeder device from different views and FIG. 7 illustrates an exploded view detailing individual components.

The materials of the pet feeder can be substantially waterproof and/or substantially shockproof to help withstand water damage, impact, and biting. In some embodiments, the pet feeder device can be powered on by tapping on the ball one or more times. For example, the pet feeder device can be powered on by tapping on the ball one, two, three, four, five, or more times. When it turns on, the pet feeder can have lights that illuminate on the sides or other location of the device. The pet feeder can be cat-friendly. The pet feeder can include a keychain holder on the outer shell for ribbon, feather, or other inserts that can entertain a pet such as a cat. The outer shell can be easily replaceable by a user with outer shell spare parts. Alternatively, the lid 1 and the top cover portion 2 can be a single piece.

The pet feeder device can be closed tightly with the lid 1. The lid 1 can secure to the top cover portion 2 and/or be rotated to lock in place on the top cover portion 2 of the pet feeder device. The top cover portion 2 can be secured to the bottom cover portion 12 and/or be rotated to lock in place

The pet feeder device can store and dispense dry food at specified times, such as one, two, or three or more times a day. The device can include a food storage holder 5 with a rotatable food divider 4 that splits the holder into one or more compartments, such as one, two, three, or more compartments. The food divider 4 can be rotated using the rotation motor 6. The MCU can include memory for storing pre-set feeding timings or schedules that the user can configure using the application. At a specified feeding time, the speaker can play a recorded voice recording that is transmitted and stored in the MCU to alert the pet. The MCU can then activate the rotation motor 6 and rotate the food divider 4 until one of the compartments is aligned with the treat opening 3 in the outer shell, which provides the pet access to the food. Subsequently, the same procedure can be used at the next feeding time. In order for the food to be dispensed, the user can move the pet feeder device with the application, causing the device to roll and the food to fall out. Alternatively, the pet can move and push the ball until the food in the particular compartment is able to fall out. The smell of the food can encourage the pet to continuously push the ball to knock the food out. In some embodiments, The treat opening 3 can be opened or closed with an application-controlled door. A user can open or close the door using an input button on the application. When the treat opening door is closed the food will not be able to fall out. This can help prevent overfeeding, especially when the user wants to play with the pet via ball movements.

To refill the pet feeder device with food, the user can unlock the pet feeder device by turning lid 1 and pouring food directly into the food storage component, which could include the food divider 4. The user could also refill the pet feeder device in other ways, such as by inserting food through the treat opening 3.

The pet feeder device can roll and move on the ground. In order to do that, the MCU can activate the gear box 7 which can cause the trackball 8 to rotate, moving the ball in all directions. The trackball 8 can be positioned within a trackball holder 9 that can be configured to allow the trackball to freely rotate without translational movement. The directions or instructions can be remotely controlled on the application. The speed of the movements can also be controlled on the application. Such movements may include making the ball move faster, slower, or making the pet feeder device brake suddenly. An accelerometer in the pet feeder can sense when the ball rolls. The accelerometer component can take a balancing point as a threshold, once the ball rotates beyond that point, the accelerometer can register that rotation as a roll and transmit this data to the MCU, which can in turn communicate this data to the application. The application can track the number of rolls, which can provide an idea of the activity level of the pet in a given time period.

In some embodiments, the pet feeder device can include a camera 10 and/or a speaker 11. The camera 10 can stream a live view from the pet feeder's perspective to the application. The user, via the application, can control the movement of the ball and watch the view of the camera change as the pet feeder device moves. The MCU can be configured to control movement of the pet feeder device so that it stays upright. For example, if the pet pushes the pet feeder causing it to roll, the camera can be configured to stay upright with the use of a gyroscope.

The gyroscope can be configured to detect when the pet feeder device is experiencing a rotation that would alter the orientation of the camera view (for example, if the feeder device was to rotate past a threshold balancing point) and communicate such rotation data to the MCU. The MCU can be configured to receive this data from the gyroscope and communicate with the gear box 7 in order to alter or adjust the movement of the trackball 8. Thus, the gyroscope, the MCU, the gear box 7, and the trackball 8, can cooperate to keep the camera substantially level and pointed forward. The speaker can broadcast voice recordings stored by the user in the application. The voice recordings, which can also be stored by the user in the application, can be used during feeding times as an alarm to alert the pet. Also, the user can broadcast his or her voice live to the pet through the application and the speaker.

The pet feeder can include a RFID sensor that detects multiple RFID tags that are worn on pet collars or on other devices worn by pets within a distance of 10 meters. The RFID sensor can gauge proximity of multiple tags and differentiate between different pets. In this way, the pet feeder can determine which pet is nearer and playing with the pet feeder.

The pet feeder device can include a wireless transceiver that is configured to communicate over a network (e.g., Wi-Fi). The network connection can be refreshed periodically (e.g., every 5 seconds). The wireless transceiver can be configured so that the pet feeder device can send and receive data packets wirelessly over the network so that the user can control the pet feeder through a software application installed on a computing device.

The application can remotely control the movement of the pet feeder device. When the user turns on the camera 10 of the pet feeder device, the application can have a navigation trackpad on a screen of the computing device. The user can utilize the navigation trackpad to control the pet feeder remotely. When the user operates the trackpad, the application can be configured to communicate with the MCU of the pet feeder device through the wireless transceiver so that the trackball 8 in the pet feeder device can move accordingly and roll the ball in specific directions. The pet feeder device can move in all directions and at different speeds. The speed of movement of the pet feeder device can be controlled by the user using the application. The application can display an input button that the user can use to adjust the movement speed of the pet feeder. To slow down, the user can push the button back down slightly. The pet feeder device can also stop suddenly. There can be a brake button on the application whereby if the user taps on it, the pet feeder device can come to an abrupt stop, causing the device to rock forward and backward. This function can attract the pet's attention. The application can include an input button that can enables the user to open or close the treat opening 3 as mentioned above.

The user can turn on an automatic play mode on the application. During the automatic play mode, the pet feeder can roll and move in random or pseudo-random directions and patterns without control from the user. This enables the feeder device to play with the pet when the owner is busy or away. The automatic play mode can be remotely activated and/or deactivated through the application.

The application can have a home page that can display a button for games. The games can be used to challenge or otherwise engage the pets. There can also be games that provide engagement for both the owner and pets, or just the pet owner or caretaker. An example of a game primarily for a pet could be a challenge for the pet to push the ball a certain number of times within a defined time period while the ball moves in a defined pattern like a circle. Games for both the user and their pet may involve an Augmented Reality (AR) view of a ball path superimposed onto the live view of the camera 10. The user will have to trace the path using the navigation pad, moving the ball. The pet will then have to complete the challenge by pushing the ball a certain number of times before a given time period expires. Each game can earn the user points. The games with higher difficulty levels can award higher points. If the user completes the challenge, the game can award more points. The points can be accumulated in the application and can be shared using social media or other methods.

The application can also track and monitor the activity level of the pet in terms of number of rolls of the pet feeder device detected by the accelerometer. The MCU can be configured to receive and store the number of rolls detected by the accelerometer and can communicate such data to the wireless transceiver. The wireless transceiver can be configured to send this data to the application. The activity level can be presented in a graph or other form and can show the number of rolls over a given time period. The time period can be customized to be hourly, daily, weekly, monthly, yearly, or some other time period. This allows the user to monitor the activity level of the pet. Also, the user can set daily goals on the application for the number of rolls for a given time period. If the number of rolls is not achieved in a particular time period, the feeder device can send a notification to the user and prompt the user to send the ball to look for the pet. The feeder device can then move towards the pet within a detectable distance of the RFID sensor. Following which, the feeder device can stimulate the pet and encourage the pet to interact with it. The application can also be configured to differentiate between rolls of the pet feeder device occurring during a time when the pet is engaged with the device and rolls occurring during movement of the feeder device when the pet is not engaged with the device. For example, the application can be used to track the rolls of the feeder device when the feeder device is within a defined distance from the RFID tags on the pet. The application could also monitor the movement of the pet by receiving data from the RFID tag on the pet. The application can also be used to separately track rolls caused by the user when the user is not engaging the pet, for example, when the user is playing a game on the application without the pet's involvement. The application can also be used to track the rolls of the pet feeder device caused by taps of the pet. For example, the application could begin tracking the rolls of the device at a point in time after the pet feeder device sensed such a tapping by the pet and could stop measuring once the device came to a complete stop. One skilled in the art will be able to recognize a variety of methods whereby activity level of a pet can be measured using the embodiment of the pet feeder device disclosed herein.

The feeder device can be barrier-sensitive. The feeder device can include one or more sensors configured to sense the presence of objects or barriers nearby to the device. For example, the feeder device can include one, two, three, four, five, or more sensors. Once it encounters a barrier or object, the feeder device can move away from it and find another path to get to the pet or other location.

The application can send multiple notifications to the user when needed. When the pet is not exercising enough, inferred from the number of rolls in a given time period of the pet feeder device, the user can receive a notification. When feeding time starts, the user can also receive a notification. When the pet plays with the ball after a stagnant period, such as a thirty-minute time period, the user can receive a notification. These notifications can provide the user with awareness of what, and how, the pet is doing. The user can also use the application to monitor the pet through use of the live camera view facilitated by the device. When the feeder device is in an automatic mode and encounters a situation where it gets stuck and is unable to move, the user can receive a notification to help maneuver the device manually or turn off the power so that it does not waste battery.

The application can be used to record voice recordings from the owner to be assigned for feeding or other alerts. The application can have a user input button that allows the user to speak to the pet, similar to a walkie-talkie, and thus the speaker can be used to project live audio. The camera can be configured to turn on and off and can communicate with the MCU. The MCU can transmit data, such as live video stream, from the camera to the wireless transceiver, and the wireless transceiver can transmit such data to a computer application over a wireless network. The camera can provide a live stream from the pet feeder's point of view and can allow the user to snap photos and videos to be shared using social media or other methods at any time.

The pet feeder can have an auto-sleep mode. When the ball is not in use for some time period, such as thirty minutes, the power consumption can be reduced to a minimum. The pet feeder can be configured to mount to a charging dock. The user can place the feeder device on the dock to charge it wirelessly. Additionally, the pet feeder device can be configured to automatically move to, and on, the charging dock when a power level on the device drops below a certain threshold. For example, the RFID sensor of the feeder device can detect the location of the charging dock where the dock is configured with an RFID tag.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated, via software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

What is claimed is:

1. A pet feeder device comprising:
a wireless transceiver configured to send and receive data packets over a wireless network;
at least one food storage compartment;
a food dispensing port configured to provide access to the at least one food storage compartment;
a locomotive device; and
a controller configured to:
communicate with the wireless transceiver;
control operation of the locomotive device in order to cause movement of the pet feeder device; and
control access to the food storage compartment.

2. The pet feeder device of claim 1, further comprising a food dispensing port door, wherein the controller is further configured to control access to the food storage compartment by opening the food dispensing port door.

3. The pet feeder device of claim 1, wherein the locomotive device comprises:
a trackball;
a trackball holder, configured accommodate the trackball and allow rotational movement of the trackball and prevent translational movement; and
a gear box, configured to communicate with the controller and rotate the trackball and thereby cause movement of the pet feeder device.

4. The pet feeder device of claim 1, further comprising a speaker configured to project recordings and live audio, the controller further configured to turn the speaker on and off.

5. The pet feeder device of claim 1, further comprising at least one light configured to illuminate on sides of the device, the controller further configured to turn the light on and off.

6. The pet feeder device of claim 1, further comprising a microphone, the controller further configured to transmit sound captured by the microphone to the wireless transceiver.

7. The pet feeder device of claim 1, further comprising a weight sensor configured to detect the weight of the at least one food storage compartment.

8. The pet feeder device of claim 7, wherein the controller is further configured to receive the detected weight of the at least one food storage compartment from the weight sensor and communicate such detected weight to the wireless transceiver, the wireless transceiver configured to send a notification over the wireless network if the detected weight falls below a threshold value.

9. The pet feeder device of claim 1, wherein the controller is configured to rotate the pet feeder device according to a random or pseudo-random pattern.

10. The pet feeder device of claim 1, further comprising a lid, a top cover portion comprising an opening that aligns with the food dispensing port, and a bottom cover portion, wherein the lid is configured to secure to the top cover portion and the top cover portion is configured to secure to the bottom cover portion.

11. The pet feeder device of claim 10, wherein the lid, the top cover portion, and the bottom cover portion are substantially waterproof and substantially shockproof.

12. The pet feeder device of claim 1, further comprising a rotation motor configured to rotate the at least one food storage compartment, wherein the controller is further configured to control access to the food storage compartment by rotating the at least one food storage compartment to align with the food dispensing port.

13. The pet feeder device of claim 1, further comprising a camera, the controller further configured to turn the camera on and off and transmit data captured by the camera to the wireless transceiver.

14. The pet feeder device of claim 13, further comprising a gyroscope configured to detect when the pet feeder device rotates past a threshold balancing point and communicate the detected rotation data to the controller, wherein the controller is further configured to receive the rotation data from the gyroscope and communicate with the locomotive device to alter the movement of the pet feeder device in order to keep the camera substantially level.

15. The pet feeder device of claim 1, further comprising an accelerometer configured to detect when the pet feeder device rotates past a threshold balancing point.

16. The pet feeder device of claim 15, wherein the accelerometer is configured to communicate the detected rotations of the pet feeder device past the threshold point to the controller, and the controller is further configured to communicate the detected rotations to the wireless transceiver.

17. The pet feeder device of claim 1, further comprising an RFID sensor configured to detect the presence of an RFID tag.

18. The pet feeder device of claim 17, wherein the controller is further configured to communicate with the RFID sensor, and, in response to the RFID sensor detecting the presence of the RFID tag, control operation of the locomotive device in order to cause movement of the pet feeder device in a direction towards the RFID tag.

19. The pet feeder device of claim 1, wherein the controller further configured to control access to the food storage compartment by rotating, with the rotation motor, the at least one food storage compartment to align with the food dispensing port automatically at a pre-set feeding time.

20. A method of operation for a pet feeder device, the method comprising:
receiving, by a wireless transceiver of the pet feeder device, data packets over a wireless data network, the data packets comprising at least one movement instruction;
controlling, by a controller of the pet feeder device, operation of a locomotive device in order to cause movement of the pet feeder device based at least in part on the at least one movement instruction;
receiving, by the wireless transceiver, data packets comprising at least one feeding instruction; and
controlling, by the controller, access to a food storage compartment based at least in part on the at least one feeding instruction.
